(19) United States
(12) Patent Application Publication
(10) Pub. No.: US 2026/0010863 A1
(43) Pub. Date: Jan. 8, 2026

(54) DELIVERY DRONE RELATED SYSTEM AND METHOD

(71) Applicants: Amir TSALIACH, Tel Aviv (IL); Yaniv KORIAT, Kfar Rosh Hanikra (IL); Harel AMIT, Modiin Maccabim Reut (IL)

(72) Inventors: Amir TSALIACH, Tel Aviv (IL); Yaniv KORIAT, Kfar Rosh Hanikra (IL); Harel AMIT, Modiin Maccabim Reut (IL)

(21) Appl. No.: 19/009,530

(22) Filed: Jan. 3, 2025

Related U.S. Application Data
(63) Continuation-in-part of application No. PCT/IL2023/050689, filed on Jul. 4, 2023.
(60) Provisional application No. 63/367,619, filed on Jul. 4, 2022.

(51) Int. Cl. G06Q 10/083; B64U 70/95; B64U 101/64; G05D 1/225; G05D 1/226; G05D 107/80; G05D 109/20; G05D 111/10; G08G 5/38

(52) U.S. Cl. CPC G06Q 10/08355; B64U 70/95; G05D 1/225; G05D 1/226; G08G 5/38; B64U 2101/64; B64U 2201/10; G05D 2107/85; G05D 2109/20; G05D 2111/17

(57) ABSTRACT

A system for directing a drone to a specific landing space comprises a landing space related control unit and a management system for overseeing landing space availability. A laser of the control unit visually generates a visual identifier at a landing space, and a camera of the drone captures the visual identifier to authenticate correctness of the landing space and to direct the drone to the landing space. In a method for directing a drone to a landing space, determination is made that a landing space worthy region is unoccupied by an obstacle or a bystander and signals indicative of airborne commands for the drone are transmitted as it increasingly approaches the landing space. An outside area deployed control unit has a microcontroller for generating a dynamic landing space within the unoccupied landing space worthy region that is sufficiently large for a drone to land upon.

This is a continuation-in-part application of International Patent Application No. PCT/IL2023/050689 filed on Jul. 4, 2023, which claims priority from U.S. Patent Application No. 63/367,619 filed on Jul. 4, 2022.

### FIELD OF THE INVENTION

The present invention relates to the field of delivery systems. More particularly, the invention relates to a delivery drone related transfer system, particularly for delivering and collecting a package in a congested urban setting or in an open area.

### BACKGROUND OF THE INVENTION

The delivery of medicinal products by drones to remote or inaccessible locations has been demonstrated to be lifesaving. However in some lifesaving events where throngs of people assemble and an emergency landing operation involving a drone has to be performed quickly, the lack of accessible landing spaces in the surroundings and the need to search for available landing spaces increases the time until medicinal products or other lifesaving service can be provided, and in certain situations such a delay could be fatal.

The use of drones to deliver packages for commercial use, such as for food delivery, has recently become more widespread. To ensure that drone deliveries will be efficient, reliable and cost effective, it would be desirable that a package be delivered directly to the consumer. In an urban setting, however, the presence of high-story buildings restricts the number of locations to which a package can be conveniently delivered. A realistic delivery location is the roof of a building, on top of which a drone is able to land but which is generally inaccessible to most tenants of the building. Even in a suburban setting where a drone lands in the yard of a private house, the resident has to leave the confines of the house and walk a sizable distance, often during inclement weather conditions, to receive the delivered package.

The delivery of packages via drones equipped with a GPS component often suffers from a lack of reliability due to its limited positioning accuracy, and it is therefore difficult to provide a proof of delivery.

It is an object of the present invention to provide a system and method for directing a delivery drone in real time to an unoccupied landing space.

It is an additional object of the present invention to provide a reliable delivery drone related transfer system that ensures timely deliveries and prevents injury to the consumer or damage to the delivered package.

It is an additional object of the present invention to provide a system and method for providing a proof of delivery involving a drone.

It is yet an object of the present invention to provide a delivery drone related transfer system for delivering a package directly to a consumer without having to leave the establishment within which he or she is regularly located.

Other objects and advantages of the invention will become apparent as the description proceeds.

### SUMMARY OF THE INVENTION

A drone related transfer system comprises a plurality of movably mounted, establishment-mounted and establishment-specific transfer assemblies for facilitating transfer of a package between an interior of a given establishment and a drone, each of said transfer assemblies comprising a landing space deploying unit configured to deploy a landing space delimited by a plurality of physical elements of a corresponding transfer assembly within which the package to be transferred is receivable at a suitable distance spaced from the given establishment, and a control unit configured to control operation of said landing space deploying unit and to confirm availability of said landing space in terms of unoccupancy and operability of said landing space deploying unit prior to commencement of a transfer operation involving said landing space; and a monitoring system for coordinating transfer operations involving said plurality of transfer assemblies, said monitoring system comprising a landing space availability map generator server, an analysis module in data communication with said server, and a communication module in data communication with said server and said analysis module, wherein the control unit of each of said transfer assemblies is configured to periodically and automatically transmit a landing space specific availability indicating wireless signal to said server, wherein said server is configured to generate a map of the landing space associated with each of said transfer assemblies in terms of their availability and geographical location, wherein said analysis module is configured to initiate transmission of a respond signal confirming a transfer order that requests performance of a transfer operation to the control unit of the transfer assembly specified in the transfer order, following determination in conjunction with generated map that the landing space associated with the specified transfer assembly is available for performance of a transfer operation, and to initiate transmission of a request signal to the control unit of the transfer assembly closest geographically to the specified transfer assembly and found to be available that is indicative of a request to perform a substitute transfer operation at the landing space of the transfer assembly closest geographically to the specified transfer assembly.

As referred to herein, a “map” is a data collection represented in various forms such as in a graphical or a tabular form.

In one aspect, the transfer assembly is interiorly mounted within the establishment and comprises a linearly extendable boom unit provided with a collapsible platform and a vertically displacing unit to ensure that the platform will displaceable through an opened window of the establishment.

In one aspect, the transfer assembly comprises means for automatically opening the window and means, such as visual means, for determining whether the window is opened.

In one aspect, the landing space is delimited by an upwardly open-ended netting receptacle.

A method for directing a drone to a landing space comprising the steps performed by an electronic control unit associated with a landing space for a drone of: wirelessly receiving a transfer order from a management system operable for dispatching a drone to the landing space; scanning the landing space by computer vision means; locally determining, with images acquired by said computer vision means, whether the landing space is unoccupied by an obstacle or a bystander; upon determining that the landing space is unoccupied by an obstacle or a bystander, transmitting an availability signal to said management system; receiving a respond signal from said management system indicative that the drone has commenced a landing operation with respect to the landing space; and transmitting, to said management system, signals indicative of airborne commands for the drone as it increasingly approaches the landing space.

In one aspect, the signals indicative of airborne commands are control signals that are transmitted over a wireless data communication channel. If the wireless data communication channel becomes disconnected, the signals indicative of airborne commands are light information that is transmitted over a visible light communication connection.

In one aspect, the drone captures, with an on board camera, a visual identifier, such as a laser beam, which is generated by the electronic control unit at the landing space, and is directed thereby to another landing space.

An outside area deployed control unit for assisting in directing a delivery drone to a landing space in the outside area comprises a microcontroller; computer vision means for locally determining in conjunction with said microcontroller whether landing space worthy regions of the outside area in which said control unit is deployed are unoccupied; a communication module for facilitating communication in one or more data networks with a management system for overseeing landing space availability and with a delivery drone specified in a landing order issued by said management system following receiving determination in conjunction with said computer vision means that the outside area associated with said unit includes at least one unoccupied landing space worthy region; a microcontroller for generating a dynamic landing space within said at least one unoccupied landing space worthy region that is sufficiently large for said specified drone to land upon; and a laser that is configured to visually generate a visual identifier at said generated dynamic landing space for authenticating correctness of said generated dynamic landing space.

### BRIEF DESCRIPTION OF THE DRAWINGS

In the drawings:

FIG. 1A is a schematic illustration of one embodiment of a transfer system;

FIG. 1B is a schematic illustration of another embodiment of a transfer system;

FIG. 2 is a schematic illustration of components of a control unit usable in conjunction with a transfer assembly;

FIG. 2A is a method of directing a delivery drone to a landing space, according to an embodiment;

FIG. 3 is a schematic illustration of a monitoring system that is able to be communicably coupled with the control unit of FIG. 2;

FIG. 4 is a perspective view of a room of an establishment within which a case containing an undeployed transfer assembly is wall mounted;

FIG. 5 is a perspective view of undeployed transfer assembly according to one embodiment, when the case of FIG. 4 is removed;

FIG. 6 is a perspective view of the undeployed transfer assembly of FIG. 5, when set to a pivoted disposition;

FIG. 7 is another perspective view of the pivoted undeployed transfer assembly of FIG. 6, showing a motor for facilitating vertical displacement of the transfer assembly;

FIG. 8 is a perspective view of the pivoted transfer assembly of FIG. 6, following vertical displacement of the boom unit to a height corresponding to a central region of a window of the establishment;

FIG. 9 is a perspective view of the vertically displaced, shown when the boom unit is extended;

FIGS. 10 and 11 are a perspective view of a collapsible platform used in conjunction with the transfer assembly of FIG. 9, showing two stages of expansion, respectively, and an embodiment o triangular platform-defining panels;

FIG. 12 is a perspective view of the transfer assembly of FIG. 9, shown when fully deployed and extending through an open window in anticipation of a transfer operation;

FIG. 13 is a schematic illustration of motors usable in conjunction with the transfer assembly of FIG. 9;

FIG. 13A is a perspective view of another embodiment of a triangular platform-defining panel usable in conjunction with the transfer assembly of FIG. 9;

FIG. 14 is a method for performing a transfer operation, according to one embodiment;

FIGS. 15A-D are a schematic illustration of another embodiment of a transfer assembly, showing four stages, respectively, of a transfer operation;

FIG. 16 is a schematic illustration in perspective view of a transfer assembly, shown when the landing space is deployed and set to an extended position;

FIG. 17 is a schematic illustration in perspective view of the transfer assembly of FIG. 16, shown when the landing space is deployed and set to a retracted position;

FIGS. 18A-C are a schematic illustration of three stages, respectively, of an exemplary scenario whereby a drone is directed to land at a specific dynamically generated landing space;

FIGS. 19-20 are a schematic illustration of the space allocation of two outside areas, respectively;

FIG. 21 is a method for communicating between an outside area deployed control unit and a drone prior to a landing operation as to the availability of generated dynamic landing spaces, according to one embodiment;

FIG. 22 is a method for authenticating the correctness of a specified landing place, according to one embodiment;

FIG. 23 is a schematic illustration of a visual indicator that is visually generated onto a landing space and is captured by the camera of a drone;

FIG. 24 is a schematic illustration of the implementation of an outside area deployed control unit for providing proof of delivery of a package to a specified landing space; and

FIG. 25 is a perspective view of an embodiment of an outside area deployed control unit.

### DETAILED DESCRIPTION OF THE INVENTION

The delivery drone related transfer system, which may be completely autonomous, facilitates either the delivery or collection (hereinafter “transfer”) of a desired package by means of an establishment-mounted transfer assembly. The transfer assembly not only facilitates the physical transfer of a package between the establishment interior and a delivery drone, but also provides a proof of transfer of the package which is indicative of the actual transfer of the package between the landing space of the transfer assembly associated with a predefined establishment and a given drone. It is accordingly unnecessary for a consumer to leave the confines of the establishment while overseeing the transfer of the package, a benefit that is great utility for disabled people and for people who are concerned when leaving an establishment momentarily unattended.

As referred to herein, an “establishment” means a walled structure that has a real geographical location such as a house, apartment, building, office, factory, and store, and a “drone” means a manned or unmanned drone, which has vertical takeoff and landing (VTOL) or single-rotor or multi-rotor capabilities. A “delivery drone” means that the primary function of the drone is for delivery purposes, but may also be used for other functions as well, such as for law enforcing purposes.

In one embodiment, the transfer assembly is in data communication with a worldwide monitoring system (WMS) that is responsible in overseeing the availability and operability of worldwide transfer assemblies and in allowing the dispatching of a drone along a predetermined airborne route to the transfer assembly specified in a transfer order if found to be available and operable. If it is determined by the WMS that the transfer assembly specified in a transfer order is currently unavailable or inoperable, a drone may be commanded to perform a transfer operation with respect to a neighboring transfer assembly agreed upon by the ordering establishment and the neighboring establishment. It will be appreciated that “worldwide” means geographically separated and not necessarily located in different continents.

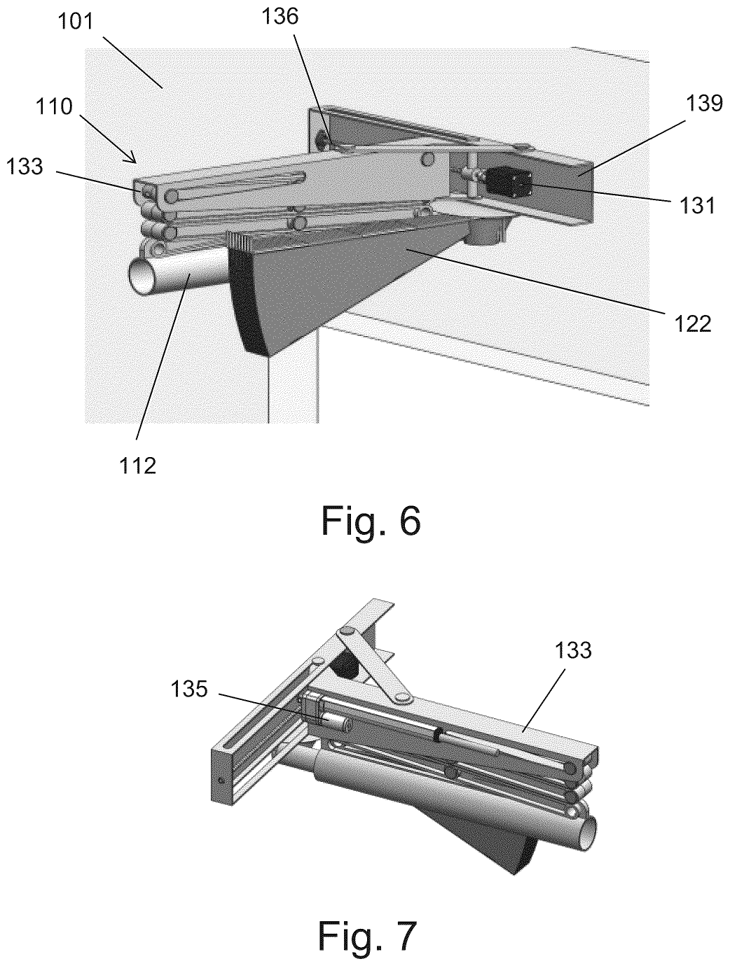

Three embodiments of novel transfer assemblies are illustrated in FIGS. 6, 15 and 17, respectively, and it is appreciated that other embodiments of a transfer assembly are also in the scope of the invention.

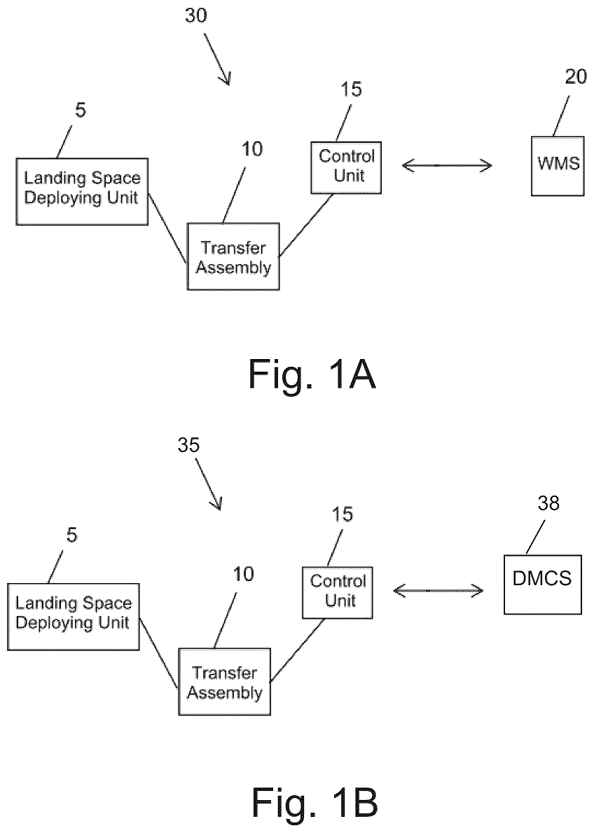

Reference is first made to FIG. 1A, which schematically illustrates a delivery drone related transfer system, generally indicated by numeral 30, according to one embodiment. Transfer system 30 comprises WMS 20, which is generally cloud based, and a plurality of transfer assemblies 10, only one of which is illustrated for simplicity. Each of transfer assemblies 10 comprises at least one mechanical, electromechanical, pneumatic, electro-pneumatic or hydraulic unit 5, or combinations thereof, for deploying a landing space which is defined by a plurality of physical elements, normally set to an undeployed condition, in response to transmission of a transfer order by WMS 20. In addition, each of transfer assemblies 10 comprises a control unit 15, generally configured as a control card, which is in data communication with WMS 20 and is also configured to positively determine proof of transfer of the package specified in the transfer order.

Following subscribing to delivery drone related transfer system 30, the administrator of the establishment enters the geographical location of the establishment-specific landing space including the floor of the building and a landing space identifier, such as a QR code, associated with the landing space deploying unit 5. When control unit 15 determines that transfer assembly is available for performance of the transfer operation specified in the transmitted transfer order, a delivery drone is dispatched in conjunction with WMS 20 to the establishment-specific landing space.

In another embodiment illustrated in FIG. 1B, a delivery drone related transfer system 35 comprises one or more transfer assemblies 10, and a drone mission control system (DMCS) 38 that coordinates most or all operations of each mission involving a fleet of drones or even only a single drone, including a takeoff operation, landing operation and transfer operation. As described above, each transfer assembly 10 comprises landing space deploying unit 5 and control unit 15. When control unit 15 determines that transfer assembly is available for performance of the transfer operation specified in a transmitted transfer order, a delivery drone is dispatched in conjunction with DMCS 38 to the establishment-specific landing space.

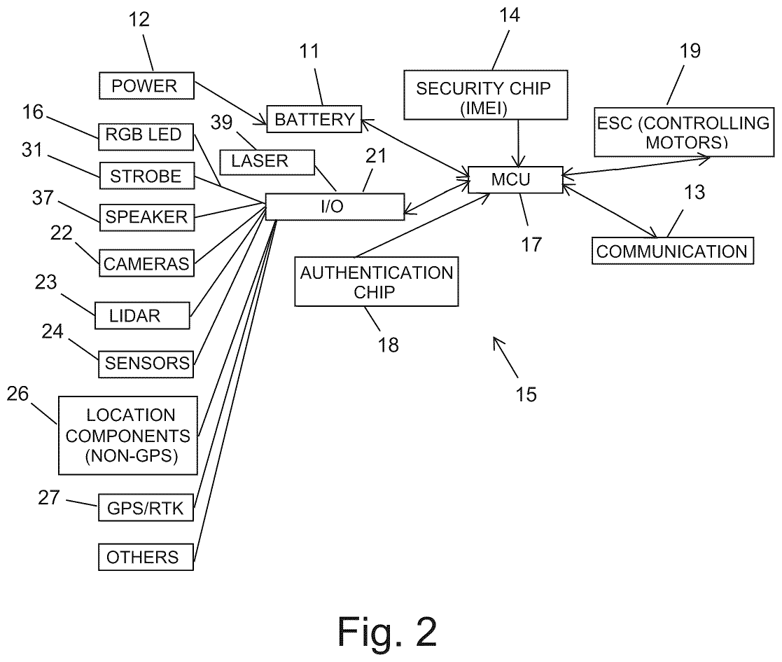

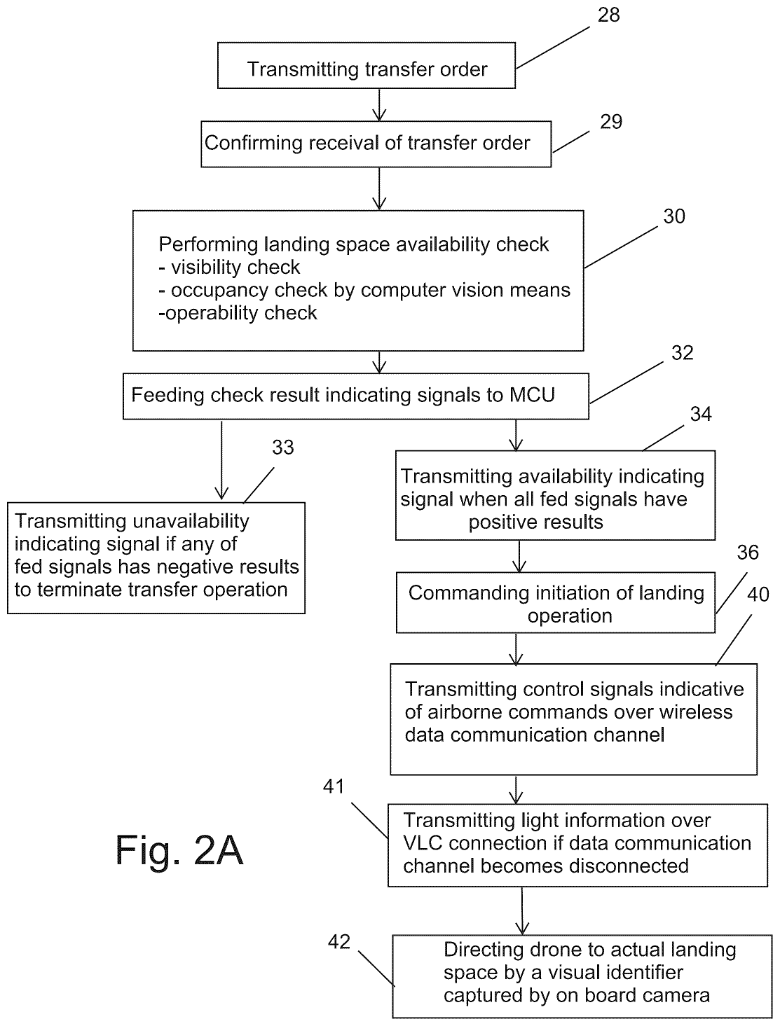

An exemplary control unit 15 provided with a transfer assembly is schematically illustrated in FIG. 2. It will be appreciated that a control unit may comprise only some of the illustrated components, or additional components to those that are illustrated.

As illustrated, control unit 15 comprises a microcontroller (MCU) 17 for controlling operations involving the transfer assembly and for making local determinations, such as proof of transfer. MCU 17, which generally comprises a memory bank and a machine learning module, and is associated with a small hard disk drive, is powered by a battery 11 or alternatively by a power system 12 such as the electrical grid or a solar power system, which of course is able to recharge the battery. Battery 11 may also be associated with a charger for recharging the battery of a delivery drone. Control unit 15 also comprises communication module 13 for facilitating communication in one or more networks, such as Bluetooth, WiFi and LTE/5G, a security chip 14 providing an international mobile equipment identity (IMEI), authentication chip 18, an electronic speed controller (ESC) 19 for regulating the operation of various motors, and an I/O card 21 for facilitating sensory, control and data transfer operations, all of which in data communication with MCU 17. I/O card 21 is able to interface with one or more of the components selected from the group of a set of cameras 22, such as stereoscopic cameras or a 360-degree or 720-degree camera, a light detection and ranging (LiDAR) scanner 23, a set of sensors 24 including for example a wind sensor, weight sensor, locked or closed status sensor, proximity sensor, and orientation sensor, a non-GPS location component 26, and a GPS/RTK component 27. Other components as well, such as a RGB LED 16, strobe light 31, speaker, 37 and laser 39, may interface with I/O card 21. These components are also powered by battery 11.

Control unit 15 is configured to replace the ground crew that is conventionally used to help land a helicopter, for example. A member of the ground crew is needed to ensure that the landing space is free from bystanders and obstacles, and then guides the helicopter toward the intended landing space by causing the helicopter to decrease its speed, make contact with the ground, and complete the landing. This analogy is also relevant to the landing of a drone when landing in crowded spaces such as urban areas. During the landing operation, the ground crew member motions to the delivery drone as to the location of the landing space and as to whether the drone is landing or lowering the package safely.

All of these ground crew actions inefficiently utilize manpower. Instead of relying on human intervention to assist in landing a delivery drone, a delivery drone is able to land safely and automatically with the assistance of control unit 15. The determination of whether the landing space, including a ground landing space or an elevated landing space provided by an establishment-mounted transfer assembly, is unoccupied is performed by computer vision. Control unit is also responsible for positively making a determination of proof of transfer of the package.

FIG. 2A illustrates a method for automatically directing a delivery drone to a specific landing space, in accordance with one embodiment.

Firstly, a transfer order is transmitted from a landing space specific control unit in step 28 to a management system associated with a delivery drone, whether a WMS, DMCS or a control system of an individual drone, including an IMEI and a geographical location associated with the given landing space and an identifier and specified destination associated with the package to be transferred. Alternatively, the transfer order is transmitted from the management system to the control unit. The management system then transmits to the landing space specific control unit in step 29, or alternatively, the control unit transmits to the management system, a confirmation that the transfer order has been received.

Afterwards, the landing space specific control unit checks in step 30 whether the landing space is available for performance of the transfer operation specified in the transmitted transfer order. The availability check is generally performed in real time, i.e. within a short period of less than 15 minutes prior to performance of the transfer operation, but one or more secondary checks may be performed at a significantly longer period such as two hours or more prior to performance of the transfer

The availability check involves a visibility check by interrogating a local meteorological station as to whether inclement weather that will greatly reduce visibility is imminent and acquiring data from local environmental sensors such as a wind velocity sensor or rain sensor.

Additionally, the availability check involves determining by computer vision means whether the landing space is unoccupied. Images of the landing space are acquired by the stereoscopic cameras and are fed into a machine learning module, which has been previously trained to classify the acquired images such as by feature extraction, object detection or pixel analysis. The output of the machine learning module is indicative of whether an obstacle that can interfere with the landing operation of a delivery drone or a bystander who can be injured by a landing delivery drone is located within the landing space.

The availability check may also involve an operability check to determine whether a landing space deploying unit needed for facilitating performance of a transfer operation is operational. The operability check may involve a review of sensed values such as a motor current or a visual check performed by the previously described computer vision means (with respect to a dedicated machine learning module that has been trained with various stages or conditions of deployment) as to whether a component of the transfer assembly has been properly deployed. It will be appreciated that if the landing space is not associated with a transfer assembly, and therefore is not associated with a deploying unit, such as when the landing space is a ground landing space, the operability check is dispensed with.

A signal indicative of the results of each of the checks is fed to the microcontroller in step 32. If any of the fed signals is indicative of negative results, including imminent reduced visibility conditions, landing space occupancy or a landing space deploying unit that is not operational, the control unit transmits, in response to analysis of the microcontroller, an unavailability indicating signal which causes the management system to terminate the transfer operation with respect to the specific landing space in step 33. On the other hand, an availability indicating signal is periodically and automatically transmitted from the control unit to the management system in step 34, such as with an interrupt, and for example with a peer-to-peer or cloud arrangement, when all of the fed signals are indicative of positive results, including good visibility, landing space unoccupancy and an operational landing space deploying unit.

The delivery drone associated management system commands initiation of a landing operation in step 36 after receiving the availability indicating signal. During the landing operation, a wireless data communication channel is established between the management system and the control unit over a selected network and via an application programming interface (API) whereby control signals indicative of airborne commands for the delivery drone as it increasingly approaches the specified landing space, such as deceleration and turning commands, are transmitted over the communication channel in step 40.

If for some reason, the wireless data communication channel becomes disconnected, a visible light communication (VLC) connection between the delivery drone and the landing space specific control unit becomes immediately established in step 41. In the VLC connection, light information indicative of the airborne commands is transmitted by one or more pulsed light sources, e.g. modulated, provided with the control unit, such as manufactured by CreeLED, Inc., Durham, NC USA, and is captured on an image sensor carried on the delivery drone. The image sensor may convert the light information to digital data and transmit the converted data to the delivery drone associated management system. The image sensor may be a CMOS image sensor and the light information may be encoded in a frequency of light pulses. One exemplary blinking light pattern is indicative that the delivery drone should turn to the right, and another exemplary blinking light pattern is indicative that the delivery drone should descend 20 meters. During the landing operation, watchdog software may be used, such as in conjunction with a keepalive signal, to determine whether the wireless data communication channel remains connected.

During the landing operation, an actual landing space may be automatically indicated in step 42 to the delivery drone by means of a QR code or any other suitable visual identifier provided at one or more landing spaces. The identifier may be visually generated on a landing space by a laser provided with the control unit. When the delivery drone is distanced by a short range from the landing space, a camera on board the delivery drone captures the visual identifier and is directed thereby as to which direction to turn in order to land at a specific location within the landing space. When the visual identifier is a QR code, the stored instructions direct the delivery drone.

In one scenario, the delivery drone is directed by the transfer order to a ground lot having a large number of landing spaces. The delivery drone approaches a first landing space on which one or more packages have already been unloaded. Since the microcontroller is aware of the occupancy of the first landing space, the laser associated with the first landing space is commanded to generate a visually noticeable laser beam that is directed to a second landing space which is unoccupied. The camera of the delivery drone captures the laser beam and is thereby directed to land at the second landing space.

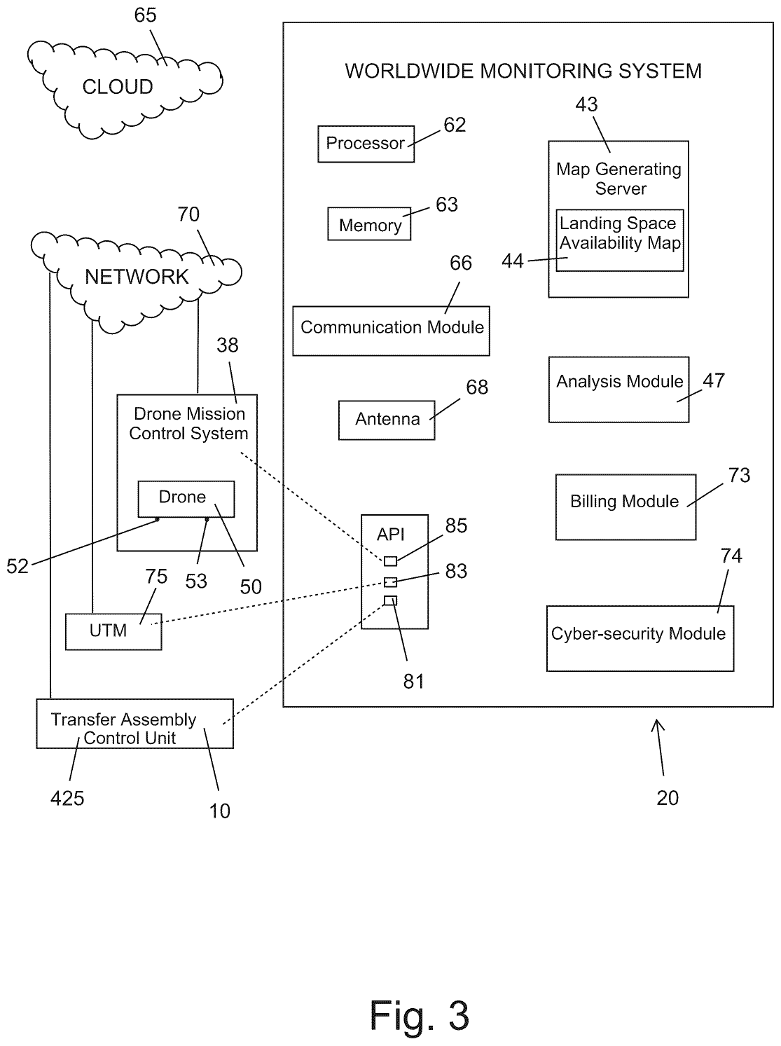

FIG. 3 schematically illustrates the architecture of WMS 20. WMS 20 may be constituted by a computing cloud 65 for coordinating the flight of a plurality of delivery drones 50 over a data network 70 during the performance of transfer operations. Each delivery drone 50 is equipped with a processor 52 and a communication module 53. WMS 20 or cloud 65 may be communicably coupled with DMCS 38 and with a plurality of transfer assemblies 10.

Network 70 may include, but is not limited to, any one or more different types of communication networks such as public networks (e.g. the Internet), private networks, wireless networks, cellular networks, or any other suitable private or public packet-switched or circuit-switched networks. Further, these networks may have any suitable communication range associated therewith and may include, for example, global networks (e.g. the Internet), metropolitan area networks, wide area networks, local area networks, personal area networks, and ad hoc local networks. In addition, these networks may include communication links and associated networking devices for transmitting network traffic over any suitable type of medium including, but not limited to, a microwave medium, a radio frequency communication medium, a satellite communication medium, or any combination thereof.

WMS 20 comprises a landing space availability map generating server 43 by which the availability status of all geographically spaced landing spaces may be known at any moment. When WMS constitutes a computing cloud, server 43 may comprise a plurality of distributed and interconnected modules. At least the following data may be accessed from the map 44 generated by server 43: transfer assembly operability status prior to being deployed (operable or inoperable), transfer assembly deployability status (deployed or undeployed), and landing space occupancy status (occupied or unoccupied). The availability status of a landing space is available when the combination of these three statuses (operable, deployed and unoccupied) is indicative that the given landing space is available for a transfer operation to be performed therewith. Landing space availability map generating server 43 may also provide the availability of open-area landing spaces over widespread geographical locations upon which a drone of a given size or weight is able to land upon. Maps that are able to be generated by server 43 are dynamic and are able to be continuously changed.

WMS 20 also comprises an analysis module 47 for analyzing the real time availability status of the various landing spaces provided by server 43. Analysis module 47 confirms a transfer order upon determination, following analysis of the generated map 44 or of any other output generated by server 43, that the landing space of the transfer assembly 10 specified in the transfer order is available for performance of a transfer operation. On the other hand, if the transfer assembly specified in the transfer order has an unavailable status, analysis module 47 has to find an alternative landing space for the performance of the transfer operation specified in the transfer order. The generated map is analyzed by analysis module 47 to determine which landing space having an available status is closest to the landing space of the transfer assembly specified in the transfer order, for increased convenience of the administrator of the transfer assembly specified in the transfer order or of an authorized representative. The transmission of a request signal to request performance of a substitute transfer operation is initiated by analysis module 47 to the transfer assembly of the candidate alternative landing space. Upon approval by the administrator of the candidate transfer assembly, WMS 20 commands initiation of a landing operation at the landing space of the newly approved alternative transfer assembly in order to perform the transfer operation specified in the transfer order. In the event that the administrator of the transfer assembly disapproves the use of the candidate landing space, analysis module 47 transmits an additional request signal to an additional transfer assembly that is found in accordance with predetermined instructions.

WMS 20 may also comprise a billing module 73 for billing an authorized account of a transfer assembly 10 for expenses associated with a landing operation. A charged sum may be different if the transfer operation is performed at the landing space of an alternative transfer assembly. WMS 20 may also comprise a cyber-security module 74 for protecting against cyber threats.

WMS 20 or cloud 65 may be communicably coupled with an unmanned aircraft traffic management system (UTM) server 75, which is configured to allocate an airspace to each of a plurality of delivery drones 50 and to thereby grant authorization to fly along a unique flight path during the course of a transfer operation.

WMS 20 or cloud 65 may include one or more processors 62, one or more memory devices 63, and one or more communication modules 66. Memory devices 63 may include volatile memory such as RAM or non-volatile memory such as ROM and flash memory, and also may include removable or non-removable data storage including, but not limited to, magnetic storage, optical disk storage, and tape storage to provide non-volatile storage of computer-executable instructions and other data. The processors 62 may be configured to access the memory devices 63 and execute the computer-executable instructions loaded therein. For example, processors 62 may be configured to execute the computer-executable instructions of various program modules, applications, and engines of server 43 or cloud 65 to cause or facilitate various operations to be performed in accordance with one or more embodiments of the disclosure. The software components of WMS 20 or cloud 65 may be backend software components or frontend software components. Processors 62 may include any suitable processing unit capable of accepting data as input, processing the input data in accordance with stored computer-executable instructions, and generating output data.

WMS 20 or cloud 65 also includes an API that interworks with third party software. That is, API 81 interworks with the control unit of each transfer assembly 10 or with each outside area deployed control unit 425 as will be described hereinafter, API 83 interworks with UTM server 75, and API 85 interworks with DMCS 38.

When WMS 20 commands initiation of a landing operation, a dispatching command may be transmitted to DMCS 38, which in turn dispatches a specific delivery drone to the landing space of the approved transfer assembly. Prior to initiation of the landing operation, DMCS 38 interfaces with UTM server 75 to receive a unique flight path for the dispatched delivery drone during the course of the approved transfer operation. Alternatively, the dispatching command is transmitted directly from WMS 20 to UTM server 75, which in turn transmits to DMCS 38 data representative of an allocated flight path along which a delivery drone to be dispatched will fly during the transfer operation.

WMS 20 or cloud 65 may also include one or more input/output (I/O) interfaces, one or more sensors or sensor interfaces, one or more transceivers, one or more display components, one or more antennas 68 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, and a Bluetooth antenna for transmitting or receiving Bluetooth signals.

It will be appreciated that server 43 and cloud 65 may include alternate or additional hardware, software, or firmware components in addition to those described or depicted without departing from the scope of the invention.

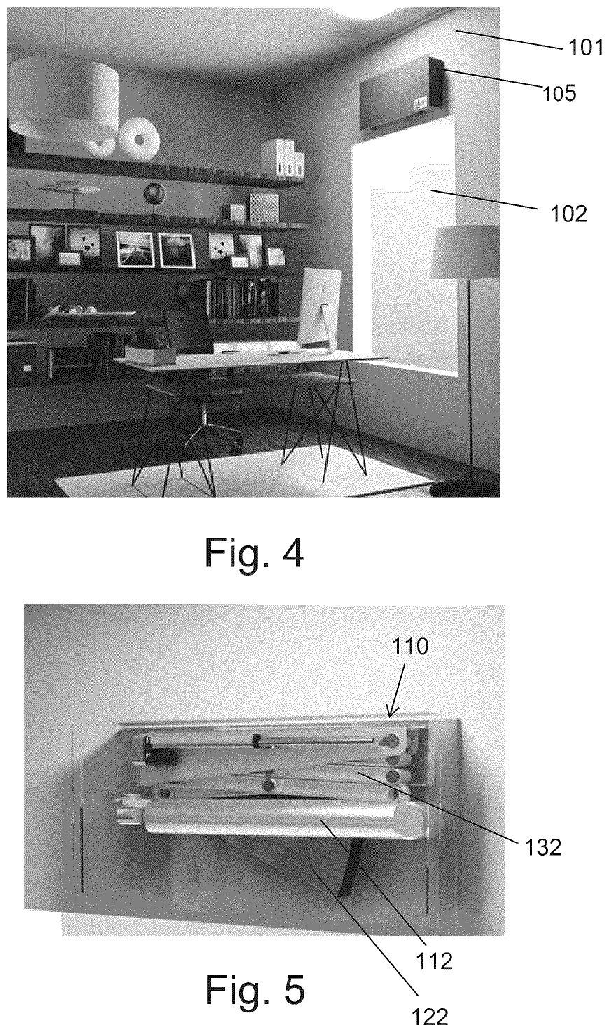

FIGS. 4-14 illustrate one embodiment of a transfer assembly 110, which is mounted within the interior of an establishment.

The establishment-mounted transfer assembly is normally concealed in a wall-mounted case 105, which may be rectilinear as shown in FIG. 4, when the transfer assembly is undeployed and compactly retained in the relatively small dimensions of the case. Case 5 is shown to be mounted on a wall 101 and above a window 102 of the establishment through which the boom and platform are intended to be displaced in order to transfer a package with the assistance of a delivery drone.

FIG. 5 illustrates transfer assembly 110 when set in an undeployed condition and when the case is removed. Transfer assembly 110 comprises an extendable boom unit 112 shown when retracted, a platform 122 connected to boom unit 112 shown when collapsed that is intended to define the landing space when deployed, vertical displacement mechanism 132 connected at its bottom to boom unit 112, and a set of motors and control components. An exemplary vertical displacement mechanism 132 is shown to be of the scissors type having a plurality of linked and folding supports arranged in a crisscross pattern.

FIG. 6 illustrates transfer assembly 110 after upper holder 133 of the scissors type mechanism 132 has been pivoted 90 degrees, together with retracted boom 112 and collapsed platform 122, by means of pivoting motor 131, threaded rod 136 connected to the output shaft of motor 131 and one or more additional transmission elements kinematically connected to rod 136. Threaded rod 136 is rotatably mointed in a bracket 139 fixed to wall 101, and upper holder 133 is pivotally connected to the same bracket.

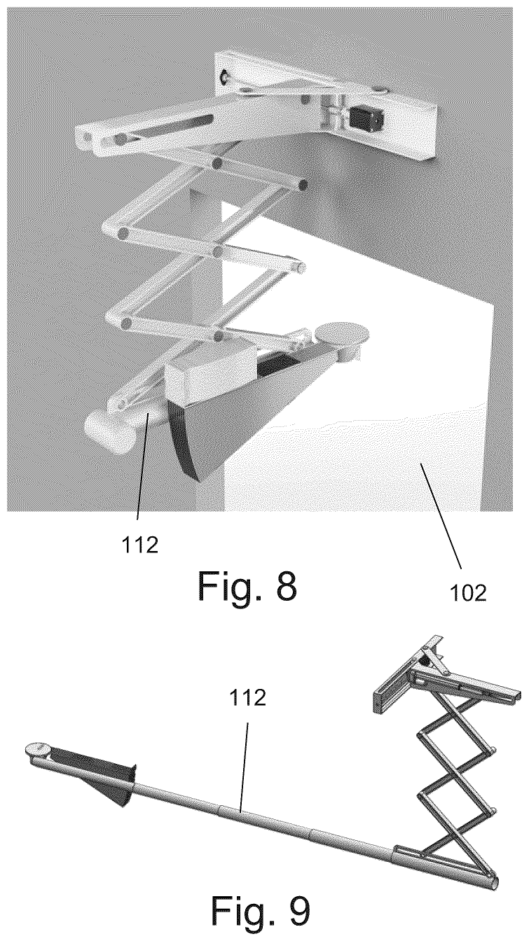

Following pivoting of upper holder 133, cable motor 135 shown in FIG. 7 which is mounted in the upper holder is activated to cause the cables associated with each folding support of the scissors-type mechanism to become extended and to thereby cause the retracted boom unit 112 to become lowered to a height corresponding to that of an intermediate region of window 102, as shown in FIG. 8. Electricity may be fed to cable motor 135, or to other motors, through a flexible cable or by wireless means.

In the next step shown in FIG. 9, boom unit 112 is linearly extended with a boom motor (not shown) that causes each link of the boom unit to become extended to a full extent.

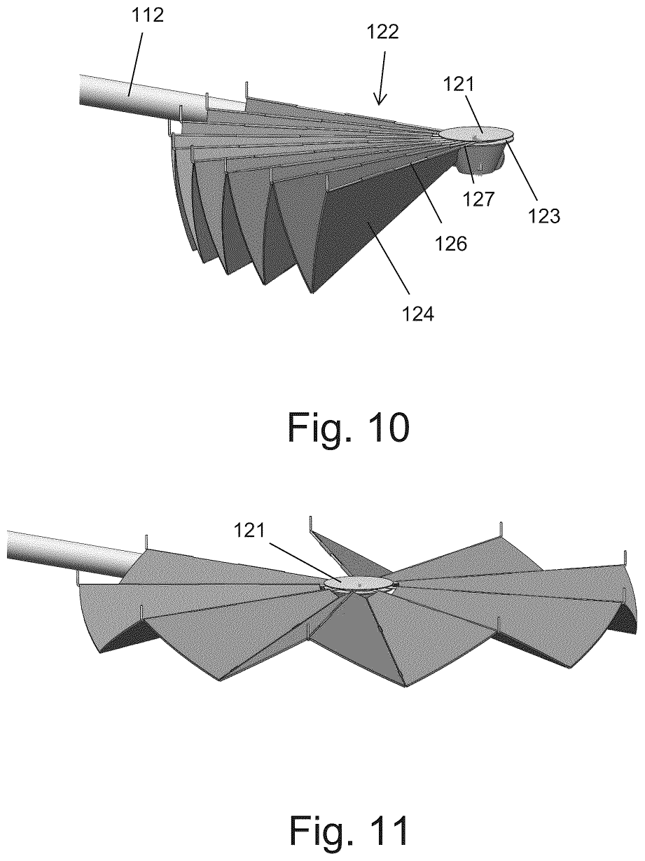

Following extension of boom unit 112, the collapsed package-transferable platform 122 undergoes expansion as shown in FIGS. 10 and 11. Platform 122 is configured with a central circular hub 121 and with a plurality of uncompromised triangular panels 124 that are each pivotally interconnected at a side which is common to two adjacent triangular panels by a radially extending rod 126, or any other suitable elongated element, and that are each truncated at a radially inward end. Alternatively, each triangular panel 124A is formed with a plurality of apertures 128, to reduce drag. The radially inward end 127 of each rod 126 is movably secured within a circumferential groove 123 formed within hub 123. This arrangement allows two adjacent triangular panels 124 to be folded about a rod 126 and horizontally stacked to provide a low volume when in a collapsed condition as shown in FIG. 6, and also allows platform 122 to become expanded when adjacent rods 126 are separated from each other and circumferentially displaced within groove 123. Each of triangular panels 124 is preferably of a structurally strong metallic material.

An elongated flexible and tensionable element (not shown) is attached to the drive shaft of a platform motor, and is routed along a first triangular panel 124 and partially along a second triangular panel adjacent to the first panel. Upon operation of the platform motor, the elongated flexible element becomes tensioned and causes the first and second panels to become tensioned as well. As a result, the first and second panels are pivoted around the common rod 126 and are urged to become circumferentially displaced along groove 123 to rotate about hub 121. This expansion method is described in U.S. Pat. No. 9,352,853, the contents of which are incorporated herein by reference.

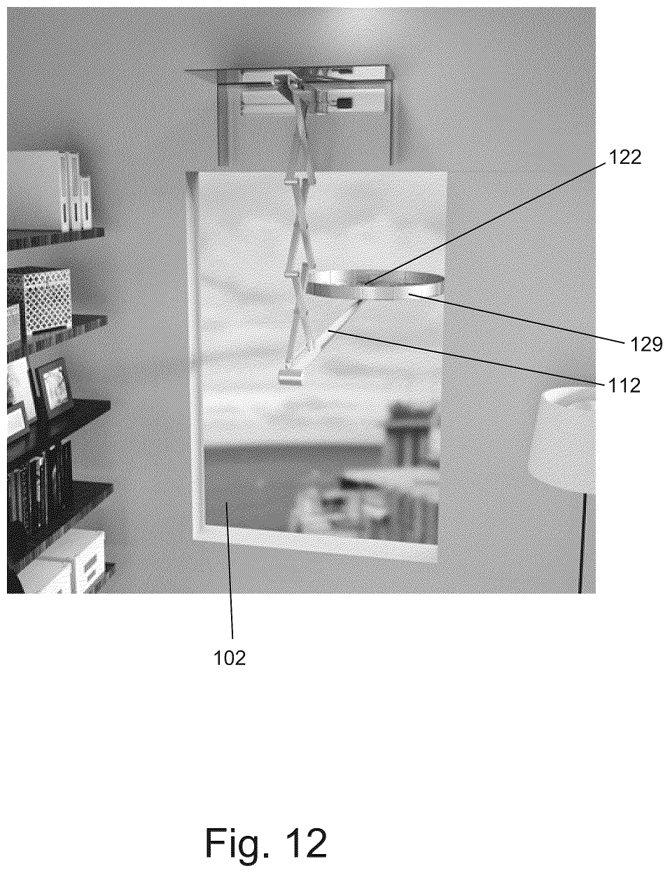

This expansion method is also suitable to expand a plurality of border elements 129, which are shown in FIG. 12 to vertically extend above, and circumferentially surround, the horizontal platform 122 when completely deployed and when boom unit 112 extends through an opened window 102 prior to performance of a transfer operation.

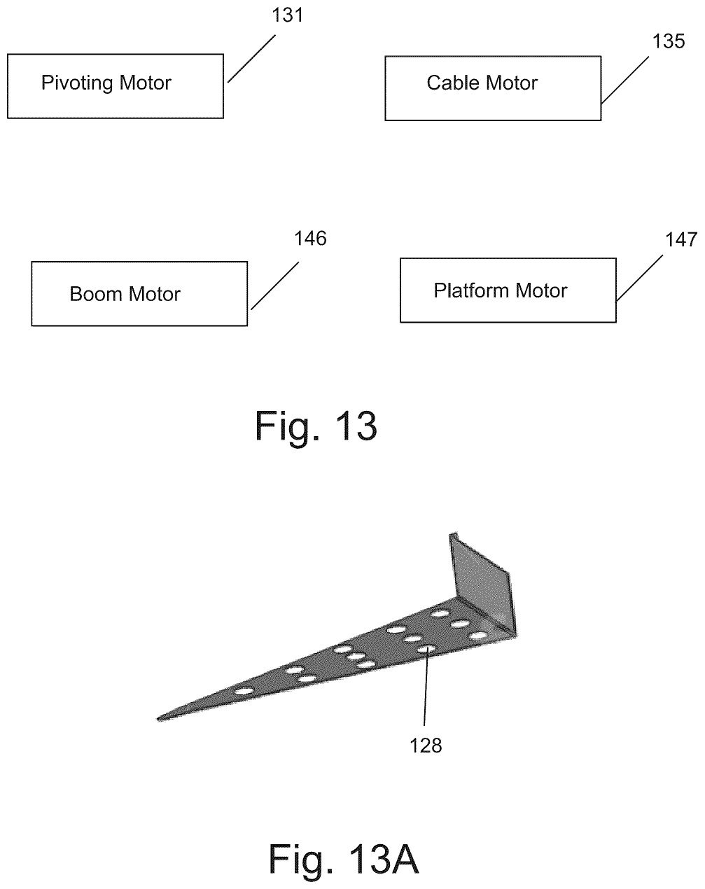

FIG. 13 illustrates different motors on which an operability check is made, including pivoting motor 131, cable motor 135, boom motor 146 and platform motor 147.

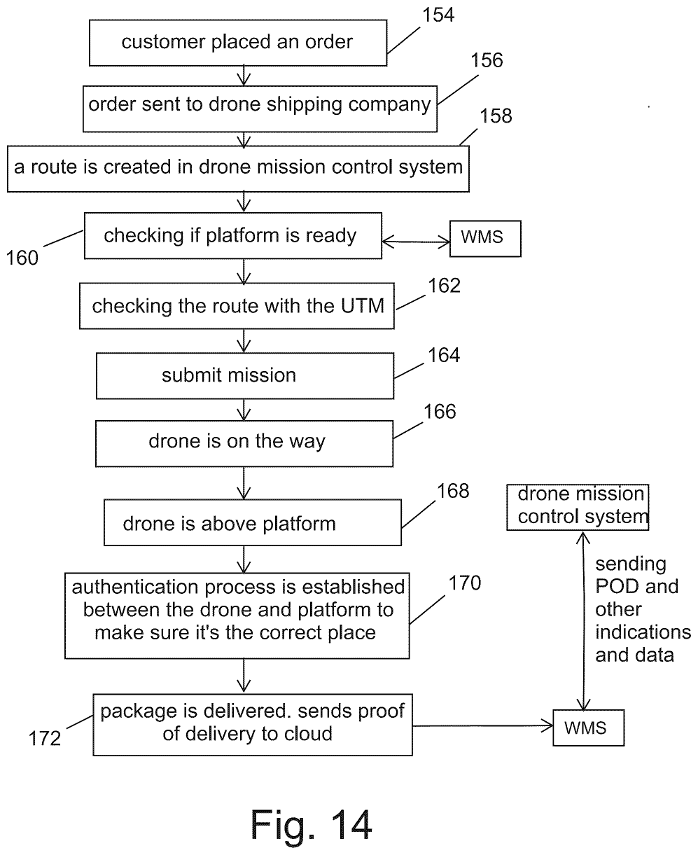

FIG. 14 illustrates a method for performing a transfer operation in conjunction with transfer assembly 110, according to one embodiment. This method is also applicable to other transfer assemblies, mutatis mutandis.

After the administrator of the transfer assembly transmitted a transfer order in step 154, the transfer order is transmitted to the drone mission control system, or to another drone dispatching organization, in step 156. The drone mission control system generates a suitable route in step 158 for the dispatched delivery drone to the landing space specified in transfer order. The control unit of the transfer assembly performs an operability check in step 160, usually in conjunction with the WMS, to determine whether the deploying unit is operational prior to deployment and whether, after deployment of the landing space, the platform is properly deployed, including a determination of whether adjacent components are properly engaged together and whether the deployed platform has a horizontal orientation. When the UTM server verifies that the generated route does not constitute a safety risk, for example a risk of collision, in step 162, the mission is submitted in step 164 and the delivery drone starts flying towards the specified landing space in step 166.

When the delivery is within short range of the platform in step 168, an authentication process takes place in step 170 between electronic monitoring equipment on board the delivery drone and the platform as to the correctness of the nearby landing space for the performance of the transfer operation specified in the transfer order. The authentication process may involve scanning a QR code provided with one or more panels of the platform. Following authentication, the package is delivered in step 172 and the control unit provides positive proof of delivery (POD) using sensors, for example by computer vision means or a weight sensor. A signal indicative of the POD may be transmitted to the cloud, and in turn to drone mission control system.

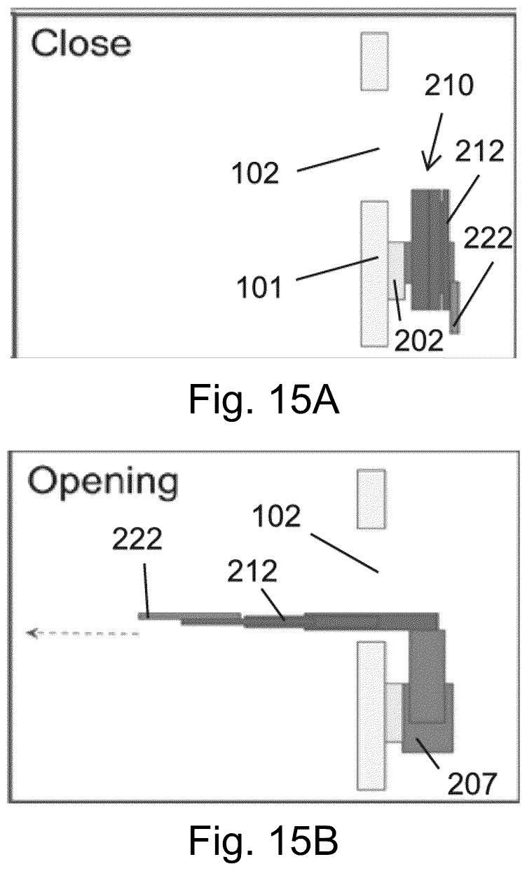

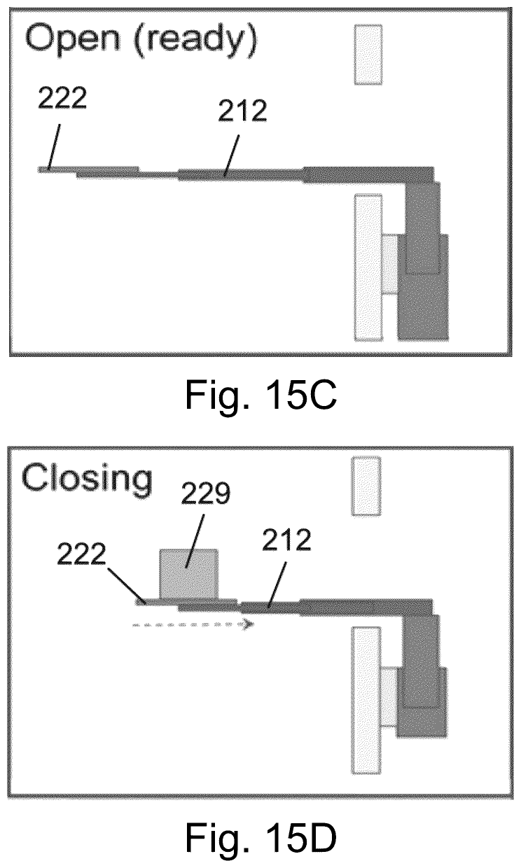

A transfer assembly 210 according to another embodiment which is mounted within the interior of an establishment is schematically illustrated in FIGS. 15A-D.

Transfer assembly 210, which is mounted by mounting element 202 to wall 101 of the establishment below window 102, is shown to be in an undeployed condition in FIG. 15A. Transfer assembly 210 comprises a displacing mechanism 207, an extendable boom unit 212 connected to displacing mechanism 207 and shown when retracted, an expandable platform 222 connected to boom unit 212 shown when collapsed that is intended to define the landing space when deployed, and a set of motors and control components.

In FIG. 15B, displacing mechanism 207 both pivots and raises boom unit 212, so that it will be horizontally oriented and positioned at a height that corresponds to a central area of window 102. Boom unit 112 is then extended to achieve a fully extended position in FIG. 15C. Platform 222 is expanded simultaneously or subsequently to the extension of boom unit 212. In FIG. 15D, a package 229 has been transferred onto platform 222, and boom unit 212 is being retracted until the package is made accessible to the administrator of the transfer assembly, or to any other authorized person.

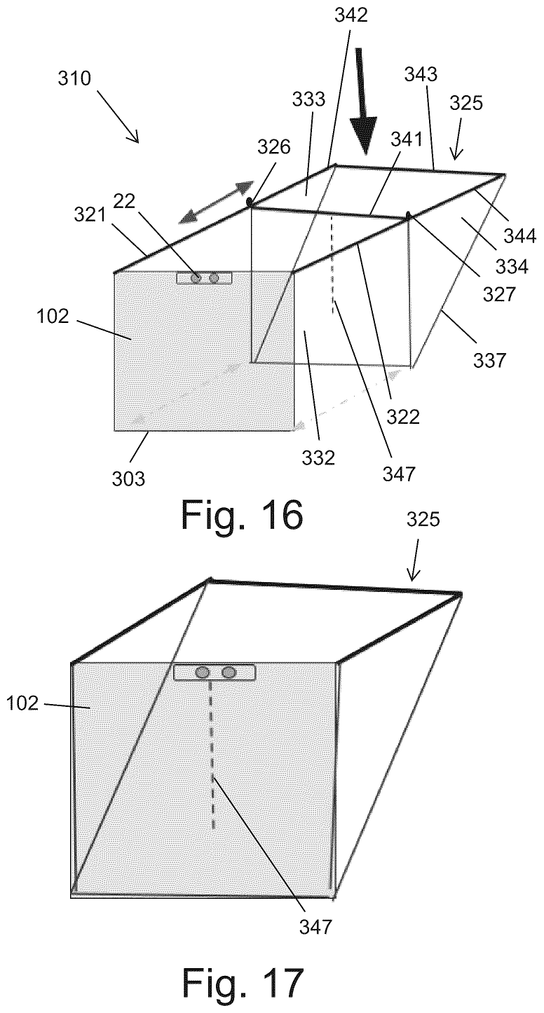

A transfer assembly 310 according to another embodiment which is mounted externally to an establishment is schematically illustrated in FIGS. 16 and 17.

The landing space associated with transfer assembly 310 is delimited by a plurality of netting walls made of lightweight and sturdy material such as nylon which are sufficiently strong to support the resist the weight of a person, and of course the weight of one or more packages and of the delivery drone. The undeployed transfer system is mounted onto the external window frame and the collapsed network is in abutment with the window. The window is not significantly darkened as a result of the mounting of transfer assembly 310 thereto by virtue of the openwork construction of the netting.

As schematically illustrated in FIG. 16, transfer assembly 310 comprises netting receptacle 325, two linearly extendable drives 321 and 322, two pivoting motors 326 and 327, and a set of control components that include at least stereoscopic cameras 22. Linearly extendable drives 321 and 322 are mounted externally on the upper element of window frame 303 and are actuated electrically, pneumatically or hydraulically as well known to those skilled in the art, being able to displace netting receptacle 325 to at least a distance of 2 m from the window frame, similar to other transfer assemblies described herein.

Netting receptacle 325 when expanded is upwardly open-ended. An exemplary configuration of netting receptacle 325 is defined by a vertical rectangular wall 332, two vertical triangular sidewalls 333 and 334, and by a bottom oblique wall 337. The upward edge of netting receptacle 325 is rigid, become comprised of a rectangular structure having bars 341-344. Pivoting motors 326 and 327 are carried by linearly extendable drives 321 and 322, respectively. Pivoting motor 326 is operatively connected at the junction of bars 341 and 342 and at the junction of walls 332 and 333. Pivoting motor 327 is operatively connected at the junction of bars 341 and 344 and at the junction of walls 332 and 334. Window-facing wall 332 is formed with a slit, e.g. vertically oriented, which extends partially therealong and is selectively securely closable or openable with a zipper 347 or any other suitable fastener well known to those skilled in the art.

Prior to a transfer operation, netting receptacle 325 is expanded by activating pivoting motors 326 and 327 so that the rectangular structure defining the upper edge of the receptacle will be pivoted away from window 102 and bottom wall 337 will be securely set to an opened configuration while extending between bar 343 and the bottom bar of wall 332. Following expansion of netting receptacle 325, linearly extendable drives 321 and 322 are activated to cause distal displacement of the netting receptacle to a sufficiently large distance away from window 102 as illustrated in FIG. 16 that is suitable from the landing of a delivery drone.

FIG. 17 illustrates netting receptacle 325 when positioned in abutment with window 102, either after delivery of a package from the delivery drone, proximal displacement of the netting receptacle, and prior to introduction of the package into the establishment, or prior to loading the netting receptacle with a package from the establishment so that the loaded package will be collected by the delivery drone. The package is able to be transferred between the establishment interior and netting receptacle 325 by opening zipper 347 in conjunction with an automated unit such as a motor and a sensor that detects the degree of opening of the zipper. Even when zipper 347 is opened, the opening that is produced is sufficiently high above the floor of the establishment to prevent a dangerous falling accident through the opening. Even if a person for some reason were to be pressed against wall 332, the netting material is sufficiently sturdy to withstand the pressing force applied by the person's weight.

At the conclusion of the transfer operation, the rectangular structure defining the upper edge of the receptacle will be pivoted towards window 102 to cause the folding of bottom wall 337 into two portions which are positionable between the window and the rectangular structure.

In another embodiment, a system and method are provided for directing a drone to a specific landing space which is not establishment-mounted. The specific landing space may be in a spacious ground lot or flat rooftop, and its borders may be dynamically and virtually demarcated in real time, depending on the size of the drone and the weight of the payload being carried, or depending on identified obstacles found in other landing spaces. The generation of dynamic landing spaces enables an emergency landing operation to be performed quickly rather than having a drone to carefully land within the limited confines of a preselected landing space. Local municipalities may allocate various lots for the landing of drones on a medical mission such as a lifesaving intervention.

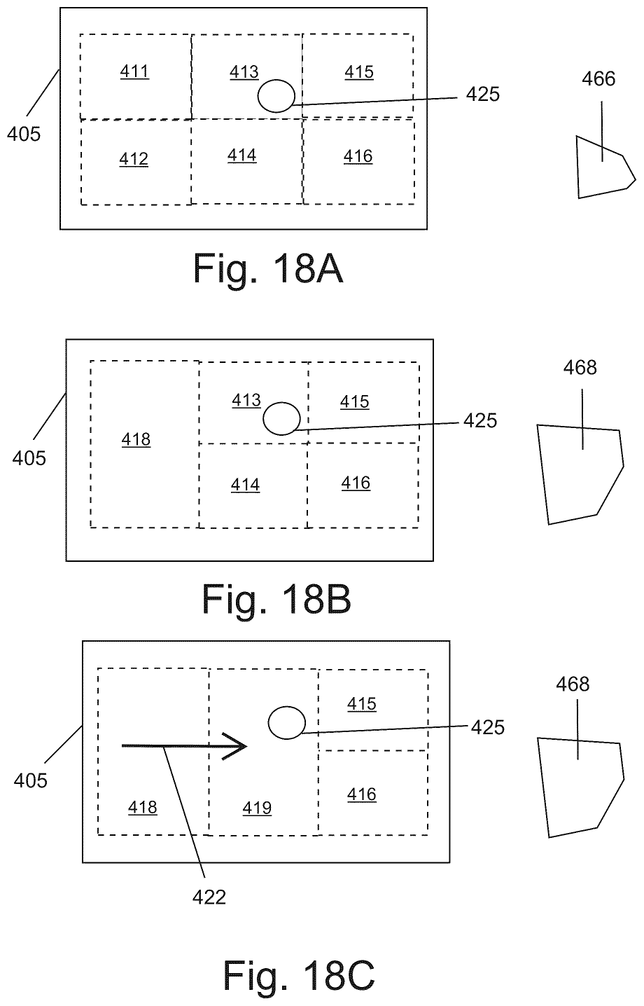

As an introduction, FIGS. 18A-C schematically illustrate three stages, respectively, of an exemplary scenario whereby a drone is directed to land at a specific dynamically generated landing space.

Control unit 425, which comprises some or all of the components illustrated in FIG. 2, generates by default six equally sized landing spaces 411-416 in FIG. 18A by subdividing uncovered and unblocked outside area 405, and each landing space is identified by coordinates. Each of landing spaces 411-416 is suitably sized for a predetermined small-sized drone 466 to land upon a given landing space, and small-sized drone 466 is informed by control unit 425 as to which landing space the landing operation should be directed. Control unit 425 is equipped with a 360-degree camera in order to be able to scan all of the generated landing spaces, and is shown to be deployed within landing space 413, but can similarly be deployed within any other landing space. A 360-degree camera or alternatively a set of stereoscopic cameras provides sufficient depth perception to determine which of the associated landing spaces is unoccupied by an obstacle or a bystander. The depth perception is sufficient to scan landing spaces that are not contiguous with the landing space in which the control unit is located, and also enables more than one drone to land simultaneously and safely.

In FIG. 18B, control unit 425 wirelessly receives a landing order from a management system, such as WMS 20 (FIG. 3) via API 81, indicating that a medium-sized drone 468 is approaching outside area 405. Since medium-sized drone 468 is overly sized for any of landing spaces 411-416 and is unable to land within their borders without risking interference with, or possible damage to, an object located in a neighboring landing space, control unit 425 generates a medium-sized landing space 418 that combines the two small-sized landing spaces 411 and 412 together. Control unit 425 communicates with medium-sized drone 468 and instructs it to land at medium-sized landing space 418.

While medium-sized drone 468 is commencing a landing operation onto landing space 418, control unit 425 reveals during a scanning operation a significantly large obstacle that is located within the borders of landing space 418 and that is liable to cause damage to medium-sized drone 468. Control unit 425 consequently generates another medium-sized landing space 419 in FIG. 18C that combines the two small-sized landing spaces 413 and 414 together, and directs medium-sized drone 468 from medium-sized landing space 418 to medium-sized landing space 419 with a distinctive visual identifier, for example the schematically illustrated arrow 422.

It will be appreciated that any other sized landing space or landing spaces are able to be dynamically generated in response to the type of drone that is specified in the transfer order.

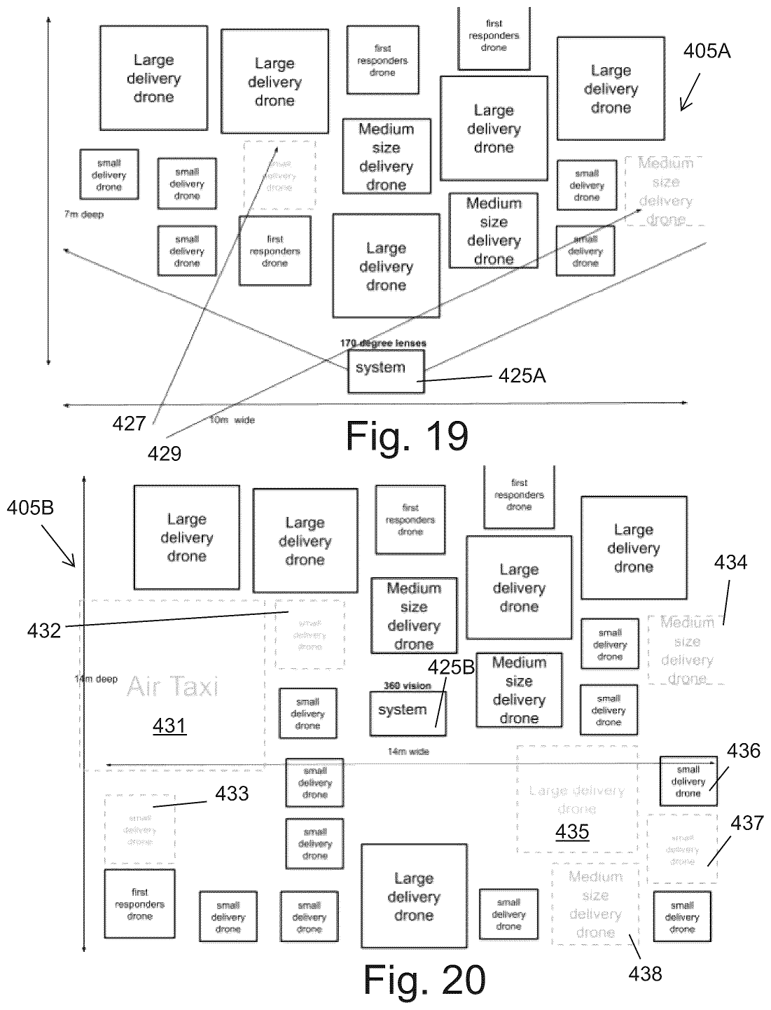

FIG. 19 schematically illustrates an exemplary space allocation of an outside area 405A to accommodate the landing thereon of differently sized drones or of drones serving a different purpose, such as for delivery purposes or first responder purposes, including for use by firefighters, police, medical teams, and law enforcement officers. Outside area 405A has an area of 70 m² and control unit 425A positioned externally to all of the allocated landing spaces comprises a camera having a directional lens, for example a 170-degree directional lens, suitable to scan all of the landing spaces. Many of the landing spaces are occupied, for example with a small-sized drone 466 or with a medium-sized drone 468. After receiving a landing order, control unit 425A analyzes the availability of landing spaces within outside area 405A for the drone specified in the transfer order in terms of landing space size and distance from a reference marker, such as location of the control unit, and determines that landing spaces 427 and 429, which are schematically illustrated with dashed lines and with faint lettering, are available.

FIG. 20 schematically illustrates an exemplary space allocation of a larger outside area 405B, e.g. having an area of 196 m². Control unit 425B is positioned internally to outside area 405B and is able to scan all of the landing spaces by virtue of a 360-degree lens. There is a different arrangement of occupied landing spaces than shown in FIG. 19. After receiving a landing order, control unit 425B analyzes the availability of landing spaces within outside area 405B for each drone specified in a landing order, such as an extremely large-sized air taxi and a small-sized, medium-sized and large-sized delivery drone, and determines that landing spaces 431-438 are available.

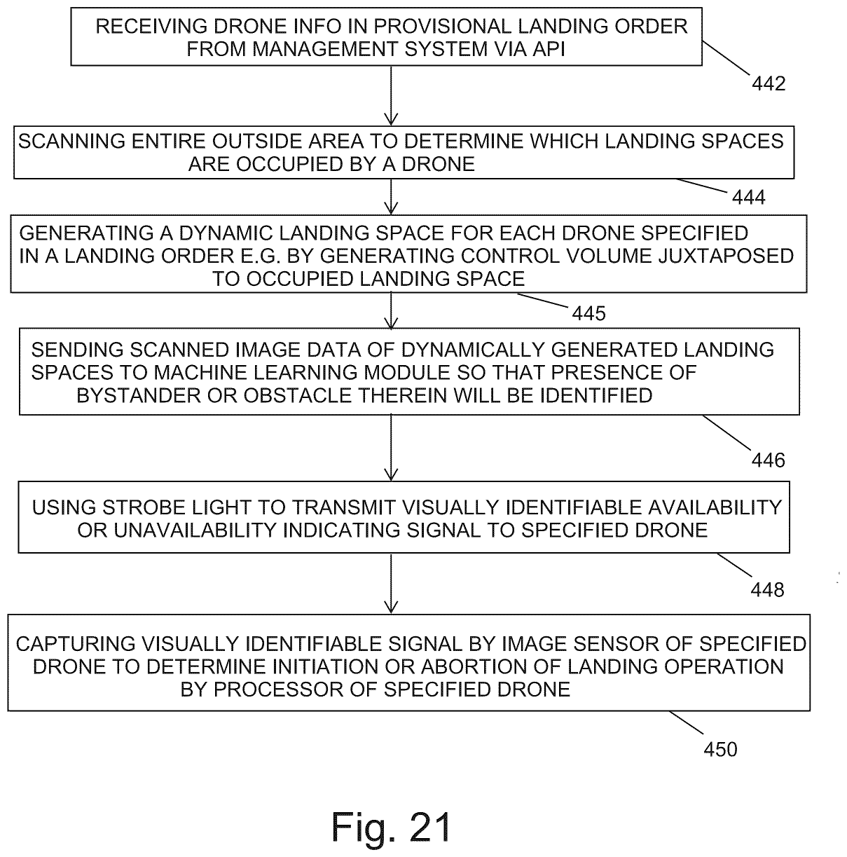

FIG. 21 illustrates a method for a control unit deployed at a given outside area to communicate in real time with a drone prior to a landing operation as to the availability of generated dynamic landing spaces. In step 442, the control unit receives a provisional landing order via its API from the management system as to the type, weight and dimensions of the drone intended to land. The provisional landing order also includes an IMEI and a geographical location associated with the given control unit. Following receiving the provisional landing order, the computer vision camera of the control unit scans the entire outside area in step 444 including natural or manmade landmarks bordering the outside area, particularly when the open area is in an urban area and there are overlying light posts or a structure of multi-story building, taking into account the distance from a reference marker, to determine which landing space worthy regions, for example having a planar ground surface, are occupied by a drone in real time. The control unit generates, within the currently unoccupied regions of the outside area, a dynamic landing space for each drone specified in a landing order. A dynamic landing space may be generated in step 445 by microcontroller 17 (FIG. 2) upon generating a drone-specific control volume or control area equal to at least the dimensions of the drone specified in the landing order, while being able to assume one of many different shapes, and determining whether the control volume or control area is sufficiently spacious when virtually juxtaposed to an occupied landing space to accommodate the landing of the specified drone thereat. The generation of the control volume or control area may be assisted by a machine learning module. In step 446, the control unit sends scanned image data of the dynamically generated landing spaces which are unoccupied by a drone to a local or cloud assisted machine learning module that is trained to identify a bystander or an obstacle of a sufficiently large size capable of causing damage to the drone specified in the landing order. If the output of the machine learning module is indicative of the presence of a bystander or of an obstacle in a given landing space, the given landing space is rendered unavailable. The control unit uses its strobe light 31 (FIG. 2), which may be based on a plurality of RGB LEDs 16, to transmit a visually identifiable availability or unavailability indicating signal to the specified drone in step 448. An availability indicating signal is transmitted if one of the dynamically generated landing spaces is found to unoccupied by a drone, bystander and obstacle. The availability or unavailability indicating signal may be transmitted in the form of a color indicative flag, wherein a GREEN light is indicative that a landing space whose coordinates are specified is currently available to be landed upon by the drone specified in the landing order, an ORANGE light is indicative that all landing spaces are currently occupied but that one of them whose coordinates are specified will become unoccupied by the time the specified drone will land, and a RED light is indicative that no landing spaces in the given outside area are presently or foreseen to being available. An orange light is able to be generated from a combination of red, green and blue lights. The image sensor of the specified drone captures the visually identifiable signal in step 450 and a processor of the specified drone processes the captured visually identifiable signal in order to command initiation, or alternatively abortion, of the landing operation. Real time communication is of critical importance due to the possibility of the introduction of a bystander or obstacle a moment before landing.

Alternatively, the control unit can transmit an availability or unavailability indicating signal to the management system via the API of the control unit, and then the management system transmits the availability or unavailability indicating signal to the specified drone via the API of the specified drone.

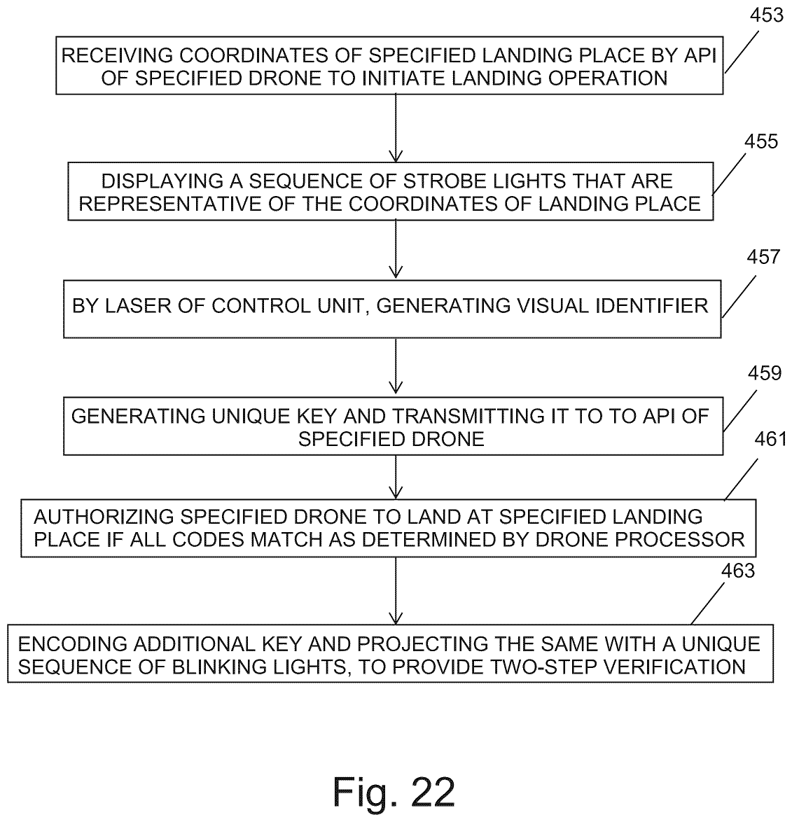

FIG. 22 illustrates a method for authenticating the correctness of a specified landing place in terms of landing space location and type of drone. For example, a manned drone will be denied to land on a rooftop due to its excessive weight.

Initiation of a landing operation commences in step 453 when the specified drone receives coordinates of the specified landing place via its API, whether an originally specified landing place or an updated landing place after an obstacle or bystander was identified on the originally specified landing place. In addition, the control unit may transmit in step 455 the coordinates of the specified landing place to the specified drone using a sequence of strobe lights that may also be representative of additional command signals. A point to point visual signal is often preferable to an RF signal in certain situations, such as when a drone is located less than tens of meters above ground level in urban regions where there are reception interruptions. Due to the reception interruptions during use of RF signals, a relatively long delay of 1-5 seconds may elapse, particularly when the signal is transmitted to the management system and then to the specified drone.

During the authentication process, the laser of the control unit is commanded in step 457 to visually generate a visual identifier, generally a QR-code, constituting a visual key which is representative of encoded data that only the specified drone can read, to facilitate a subsequent handshake process between the specified drone and the control unit associated with the specified landing place. The visual identifier is generated by the management system, or alternatively by the microcontroller of the control unit, and is transmitted to the projector of the laser, whereupon it is projected onto the ground surface of the specified landing place. The projected visual identifier has sufficiently high resolution to be seen at a distance of 10-20 m during all hours of the day and night. An exemplary laser suitable for generating the visual identifier is the Beam Brush 7000 manufactured by Kvant Lasers s.r.o, Bratislava, Slovakia.

The control unit also generates a unique key in step 459 that is transmitted to the specified drone via the management system and the API of the drone. The API-transmitted key may be identical to the visual identifier. The visual identifier is indicative of the IMEI serial number of the specified drone, as well as the defined location within the outside area of the specified landing place. The image sensor of the specified drone captures the visual identifier, and the processor of the specified drone authenticates the correctness of the specified landing place by comparing the API-transmitted key with the visual identifier on board. The specified drone will be authorized to land at the specified landing place in step 461 if the visual key, the IMEI and the API-transmitted key all match. However, the specified drone will be denied the right to land at the specified landing place if there is a mismatch in at least one of the three codes of the visual key, the IMEI and the API-transmitted key.

In another embodiment, for enhanced authentication, a two-step verification process is implemented. An additional key is encoded by the microcontroller of the control unit in step 463 and is projected by the strobe light in the form of a unique sequence of blinking lights which is captured by the image sensor of the specified drone. According to this embodiment, the specified drone will become authorized to land by its processor if only the three codes derived from the visual identifier and the light sequence generated by the strobe match, thereby ensuring a higher level of security.

Alternatively, the additional key is encoded by the processor of the specified drone and is projected by a strobe light mounted on the specified drone in the form of a unique sequence of blinking lights, which is captured by the computer vision means of the control unit associated with the specified landing place when the specified drone is in range of the control unit. According to this embodiment, the specified drone will become authorized to land upon transmission of a first authentication signal from the specified drone to the control unit when the three codes derived from the visual identifier match and upon transmission of a second authentication signal from the microcontroller of the control unit to the processor of the specified drone when the light sequence generated by the strobe of the specified drone matches.

When the handshake process is completed, the camera of the control unit is able to view and identify the specified drone at a height above ground level of 80-90 meters, and the microcontroller of the control unit verifies that the landing operation is being performed as expected. However, if the camera of the control unit fails to view the specified drone during the expected time of landing as received from the management system, the microcontroller determines that that the specified drone went out of control, malfunctioned or landed at an incorrect landing space. Even when the handshake process is completed, a change to the specified landing place may be instantaneously made, due to the identification of a bystander or obstacle. A proof of delivery may be made only after completion of the landing operation.

The following is an exemplary list of sequences of blinking strobe lights and a corresponding system-defined meaning of the sequence:
i. a strobe sequence of green light for 0.1 ms, orange light for 0.1 ms, green light for 0.1 ms, orange light for 1 ms, green light for 0.1 ms and orange light for 0.1 ms is indicative that system is operational, specified landing space is unoccupied, no hazards have been identified-however the control unit has not yet completed the handshake process with the specified drone
ii. a continuous orange light means that the control unit has not yet completed the handshake process with the specified drone and moving hazards, such as children and pets, in the vicinity of the specified landing space have been identified
iii. a strobe sequence of red light for 0.1 ms, orange light for 0.1 ms, red light for 0.1 ms and orange light for 1 ms is indicative that system is operational, specified landing space is occupied, moving hazards have been identified, and the control unit has not yet completed the handshake process with the specified drone
iv. a strobe sequence of red light for 0.1 ms, green light for 0.1 ms, red light for 0.1 ms, green light for 1 ms, red light for 0.1 ms and green light for 0.1 ms is indicative that system is operational, specified landing space is occupied, no hazards have been identified, and the control unit has completed the handshake process with the specified drone
v. a strobe sequence of green light for 0.1 ms, orange light for 0.1 ms, green light for 0.1 ms, orange light for 1 ms, green light for 0.1 ms and orange light for 0.1 ms is indicative that the system is operational, specified landing space is unoccupied, no hazards have been identified, and the control unit has not yet completed the handshake process with the specified drone
vi. a continuous green light is indicative that the system is operational, specified landing space is unoccupied, no hazards have been identified, and the control unit has completed the handshake process with the specified drone—for example the camera of the control unit is able to capture the specified drone
vii. a continuous red light means that the landing operation should be aborted
viii. other strobe sequences provide different meanings, such as ascend 10 m and then hover, change landing space, land and turn off motors, move to the right, and move to the left

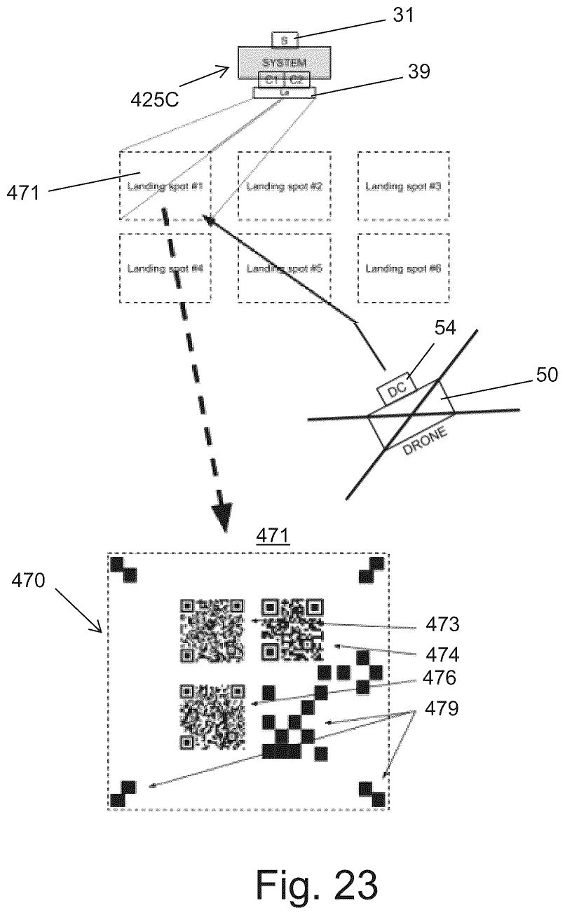

FIG. 23 schematically illustrates the capturing of a visual indicator 470 that is visually generated by laser 39 of control unit 425C, which also comprises strobe light 31 as described above, onto a landing space 471 by the camera 54 of a drone 50. Visual indicator 470 includes a first QR-code 473 that is indicative of the IMEI of the specified drone, a second QR-code 474 that is indicative of the IMEI of the control unit associated with the specified landing space, a third QR-code 476 that is indicative of the IMEI of the general location in terms of latitude and longitude of the specified landing space, and a plurality of fixed location markers 479 which are dispersed in different regions of the specified landing place, including at its corners.

The drone camera is able to be locked on the fixed location markers 479 in order to maintain a constant distance of the drone from them and to thereby be centered with respect to the specified landing place throughout the landing operation. The drone is accordingly able to land at a precise location by virtue of the fixed location markers. Use of the fixed location markers constitutes a cost effective way to ensure accurate landing. While a GPS component is relatively inexpensive, its positioning accuracy is often degraded by a deviation ranging from 1-5 meters due to various factors such as satellite signal blockage and reflection of signals from buildings or walls. Although a differential global positioning system enhances the accuracy of positional data available from GPS components, very expensive antennas would be needed at the ground based control unit and at the airborne specified drone.

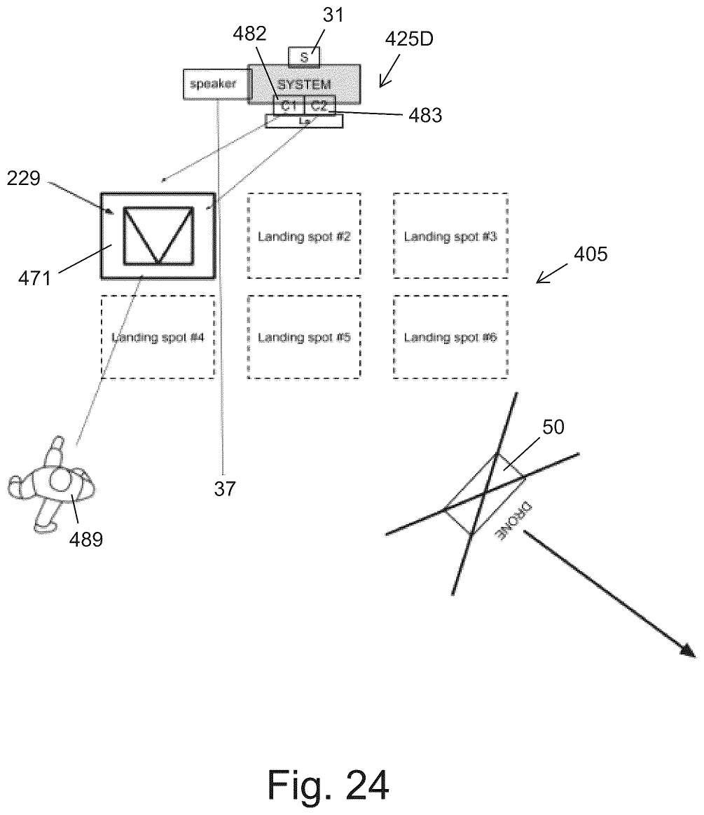

FIG. 24 schematically illustrates the implementation of control unit 425D for providing proof of delivery of a package 229 to a specified landing space 471 of open area 405. Control unit 425D comprises two stereoscopic cameras 482 and 483 for imaging and recording the delivery of package 229 from drone 50, after landing in response to commands provided by strobe light 31, onto specified landing space 471. Microcontroller 17 (FIG. 2) of control unit 425D may be equipped with an image processor and a machine learning module to determine from the captured images when the package has been lowered onto the ground surface of specified landing space 471, or delivered onto any other designated surface for receiving the package. After positively determining proof of delivery, the microcontroller activates speaker 37 to request from authorized personnel, a robot 489 or any other suitable machine, or alternatively transmits a command signal thereto, to transfer package 229 to a predetermined location. Additionally, drone 50 is granted authorization, from control unit 425D, to takeoff and fly to another destination after completing the drop-off of the package.

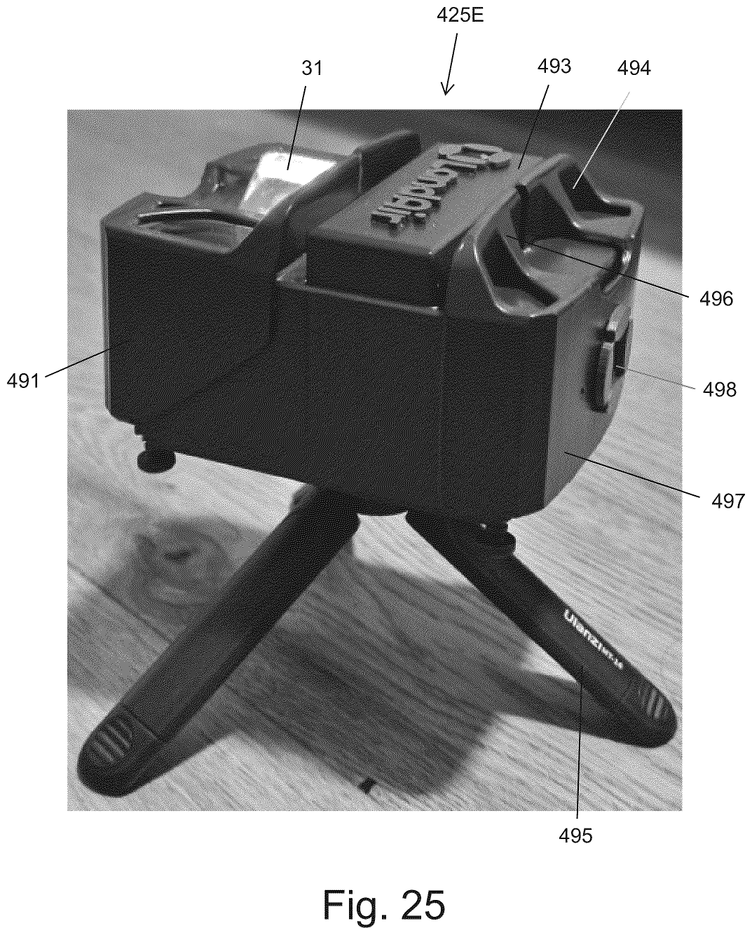

FIG. 25 illustrates an exemplary configuration of a tangible control unit 425E. Control unit 425E is configured with a sturdy rectangular casing 491 that is sufficiently sealed so that the electronic components, such as a microcontroller and communication module, housed therewithin will not be damaged by rain or snow falling on the open area. Strobe light 31 is visible at one end of the upper surface of casing 491. The computer vision means such as stereoscopic cameras are mounted within secondary housing 493 protruding from casing 491, and are able to image the surroundings through corresponding windows 494 formed in a vertical shield 496 that protects the lens from sunlight. These computer vision means may be assisted by a vision enhancer, such as a LiDAR scanner 23 (FIG. 2) or a radar-based ADAS system that can successfully scan the vicinity of the control unit during low visibility conditions. The laser is positioned below secondary housing 493 and its beam is emitted through opening 498 formed in front wall 497 of casing 491.

Projecting downwardly from casing 491 is a tripod 495 for stabilizing the casing when in contact with the ground surface of an open area. The legs of tripod 495 may be foldable to facilitate portability, allowing control unit 425E to be transported in the motor vehicle of for example a law enforcement or public health professional. During an emergency situation that requires a drone to land in an unanticipated location, the control unit is simply removed from its container within the motor vehicle, positioned on top of the open air and becomes paired with the dedicated management system. Alternatively, control unit 425E may be fixedly installed in the open area by means of tripod 495 or any other suitable fixture.

The following is an example of components housed within casing 491: a Raspberry Pi controller, a 170-degree Raspberry Pi camera module, a 5G module, a WiFi and Bluetooth module, a strobe light based on a 5×5 LED matrix, Ethernet ports, HDMI ports, a power bank/internal battery, a charging port, a voltage regulator for 5V, 9V and 12V, a small solar device for charging the battery during the day, 12C/UART serial communication for the LiDAR scanner, USB-A and USB-C ports and an IP68/65 waterproof enclosure.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A system for directing a drone to a specific landing space, comprising:
a) one or more landing space related control units, each of said control units comprising a microcontroller, a communication module for facilitating communication in one or more data networks, and computer vision means for locally determining whether a corresponding landing space is unoccupied by an obstacle or a bystander;
b) one or more drones, each of said drones comprising a processor, an image sensor in data communication with said drone processor for acquiring landing space related images, and a communication module for communicating over a data network; and
c) a management system for overseeing landing space availability by being able to communicate with each of said landing space related control units and with said one or more drones, said management system comprising one or more processors, one or more communication modules and one or more memory devices that includes (i) a first application programming interface (API) configured to interwork with the microcontroller of the control unit of a landing space specified in a landing order after the management system receives an availability indicating signal from the microcontroller of the control unit of the specified landing space if found by the computer vision means to be unoccupied and (ii) a second API configured to interwork with a drone mission control system (DMCS) for coordinating operations of each mission involving a given drone including dispatching the given drone along a predetermined airborne route and transmitting control signals over a wireless data communication channel to the given delivery drone that are indicative of airborne commands to be carried out by the given drone as it increasingly approaches the specified landing space,
wherein the control unit associated with the specified landing space comprises one or more stereoscopic cameras or a LIDAR scanner for scanning a landing space to determine landing space occupancy, and a laser that is configured to visually generate a visual identifier at the specified landing space in response to operation of the laser, the visual identifier indicating a specific location within the specified landing space,
wherein the image sensor of the given drone is configured to capture the visual identifier visually generated at the specified landing space and the processor of the given drone is configured to suitably process data associated with the captured visual identifier so as to authenticate correctness of the specified landing space and to direct the given delivery drone to the specific location within the specified landing space.

2. The system according to claim 1, wherein the laser is commanded to generate a laser beam that is directed in a direction toward the specified landing space.

3. The system according to claim 1, wherein the laser is configured to generate a QR code and the processor of the given drone is configured to retrieve stored instructions associated with the QR code that direct the given drone to the landing position.

4. The system according to claim 1, wherein the control unit associated with the specified landing space additionally comprises one or more pulsed light sources that are configured to generate a blinking light pattern being indicative of a movement to be carried out by the given drone during a landing operation, a visible light communication connection in a form of the blinking light pattern being established between the given drone and the control unit of the specified landing space upon disconnection of the wireless data communication channel to the given drone.

5. The system according to claim 1, further comprising a landing space availability map generating server in data communication with the management system by which an availability status of all geographically spaced landing spaces is able to be determined at any moment.

6. The system according to claim 1, wherein the given drone is autonomously flyable along the predetermined airborne route.

7. The system according to claim 1, wherein the microcontroller of the control unit of the specified landing space is operable to transmit an unavailability indicating signal to the management system that is indicative of an obstacle or a bystander being located in the specified landing space, the management system in response operable to command termination of a landing operation with respect to the specified landing space via the second API.

8. The system according to claim 7, wherein the laser is commanded to generate a laser beam that is directed in a direction toward another landing space that is unoccupied when the management system receives the unavailability indicating signal in response to a determination made by the associated computer vision means that the specified landing space is occupied.

9. The system according to claim 1, wherein each of the control units additionally comprises one or more components selected from the group of a 360-degree camera, a 720-degree camera, a wind sensor, a proximity sensor, an orientation sensor, a non-GPS location component, a GPS/RTK component, a RGB LED, a strobe light, and a speaker.

10. The system according to claim 3, wherein the QR code generated at the specified landing space is directable to another landing space.

11. A method for directing a drone to a landing space in a lot having a plurality of landing spaces, comprising the following steps performed by a given landing space associated electronic control unit adapted to assist in landing a dispatched drone:
a) wirelessly receiving a landing order from a management system for overseeing landing space availability, a given control unit having a known geographical location being specified in the landing order;
b) scanning all associated landing spaces by computer vision means provided with one or more stereoscopic cameras or a LIDAR scanner for determining landing space occupancy;
c) locally determining, with images acquired by said computer vision means, whether the associated landing spaces are unoccupied by an obstacle or a bystander;
d) upon determining that the associated landing spaces are unoccupied by an obstacle or a bystander, transmitting an availability signal to said management system;
e) receiving a respond signal from said management system indicative that the dispatched drone has commenced a landing operation with respect to the associated landing spaces; and
f) operating a laser that visually generates a visual identifier provided at one or more of the associated landing spaces which, when captured by an image sensor on board the dispatched drone, facilitates processing of data associated with the captured visual identifier so as to authenticate correctness of a specified landing space and to direct the dispatched drone to a specific location within the specified landing space using instructions stored in the visual identifier and directing the dispatched drone to one of the plurality of associated landing spaces.

12. The method according to claim 11, further comprising generating a blinking light pattern being indicative of a movement to be carried out by the dispatched drone during the landing operation, a visible light communication connection in a form of the blinking light pattern being established between the dispatched drone and the landing space associated control unit upon disconnection of a wireless data communication channel between the management system and the dispatched drone over which are transmittable control signals that are indicative of airborne commands to be carried out by the dispatched drone as it increasingly approaches the landing spaces associated with the given control unit.

13. The method according to claim 11, wherein the visual identifier is a QR code from which stored instructions that direct the dispatched drone to the landing position are retrieved.

14. The method according to claim 13, further comprising directing the generated QR code to another one of the plurality of associated landing spaces.

15. The method according to claim 11, wherein the laser generates a laser beam being the visual identifier that points at the one of the plurality of landing spaces.

16. The method according to claim 11, wherein all landing spaces associated with the control unit are scanned by the computer vision means which includes a light detection and ranging (LiDAR) scanner.

17. The method according to claim 11, wherein the dispatched drone is a delivery drone and the transfer order is a transfer order to deliver a desired package with respect to the known geographical location of the given control unit, or the dispatched drone is a manned drone.

18. The method according to claim 17, wherein the computer vision means of the given control unit images the desired package to provide positive proof of delivery (POD) and a signal indicative of the POD is transmitted from the given control unit to the management system.

19. The method according to claim 11, further comprising scanning all associated landing spaces by computer vision means provided with a 360-degree camera or a 720-degree camera.

20. An outside area deployed control unit for assisting in directing a delivery drone to a landing space in the outside area, comprising:
a) a microcontroller;
b) computer vision means for locally determining in conjunction with said microcontroller whether landing space worthy regions of the outside area in which said control unit is deployed are unoccupied;
c) a communication module for facilitating communication in one or more data networks with a management system for overseeing landing space availability and with a delivery drone specified in a landing order issued by said management system following receiving determination in conjunction with said computer vision means that the outside area associated with said unit includes at least one unoccupied landing space worthy region;
d) a microcontroller for generating a dynamic landing space within said at least one unoccupied landing space worthy region that is sufficiently large for said specified drone to land upon; and
e) a laser that is configured to visually generate a visual identifier at said generated dynamic landing space for authenticating correctness of said generated dynamic landing space.
